(19) United States
(12) Patent Application Publication
(10) Pub. No.: US 2021/0176314 A1
(43) Pub. Date: Jun. 10, 2021

(54) METHOD AND SYSTEM FOR SYNCHRONIZING DATA, MOVABLE PLATFORM, AND READABLE-STORAGE MEDIUM

(71) Applicant: SZ DJI TECHNOLOGY CO., LTD., Shenzhen (CN)

(72) Inventor: Gaoping BAI, Shenzhen (CN)

(21) Appl. No.: 17/182,181

(22) Filed: Feb. 22, 2021

Related U.S. Application Data
(63) Continuation of application No. PCT/CN2018/102314, filed on Aug. 24, 2018.

(51) Int. Cl. H04L 29/08

(52) U.S. Cl. CPC H04L 67/1095; H04L 67/2852

(57) ABSTRACT

The present disclosure provides a method of synchronizing data in a movable platform. The method includes storing the data in a target storage medium; obtaining a synchronization strategy for the data; determining a target synchronization medium based on the synchronization strategy; and synchronizing data to the target synchronization medium based on the synchronization strategy.

### CROSS-REFERENCE TO RELATED APPLICATION

This application is a continuation of International Application No. PCT/CN2018/102314, filed on Aug. 24, 2018, the entire content of which is incorporated herein by reference.

### TECHNICAL FIELD

The present disclosure relates to the technical field of data synchronization and, more specifically, to a data synchronization method, a data synchronization system, a movable platform, and a computer-readable storage medium.

### BACKGROUND

The storage strategy of electronic devices is often fixed. For example, when the electronic device has multiple storage medium, the data collected by the electronic device will only be stored in one of the storage medium, and will not be synchronized to other storage medium. In addition, users cannot configure the synchronization strategies independently, which results in low flexibility and poor user experience.

### SUMMARY

One aspect of the present disclosure provides a method of synchronizing data in a movable platform. The method includes storing the data in a target storage medium; obtaining a synchronization strategy for the data; determining a target synchronization medium based on the synchronization strategy; and synchronizing data to the target synchronization medium based on the synchronization strategy.

Another aspect of the present disclosure provides a movable platform. The movable platform includes a processor; and a memory storing program instructions that, when being executed by the processor, cause the processor to: store data in a target storage medium; obtain a synchronization strategy for the data; determine a target synchronization medium based on the synchronization strategy; and synchronize data to the target synchronization medium based on the synchronization strategy.

Another aspect of the present disclosure provides a data synchronization system. The data synchronization system includes a movable platform, and an external device connected to the movable platform, the movable platform including a processor and a memory storing program instructions that, when being executed by the processor, the program instructions cause the processor to: store data in a target storage medium; obtain a synchronization strategy for the data; determine a target synchronization medium based on the synchronization strategy; and synchronize data to the target synchronization medium based on the synchronization strategy.

### BRIEF DESCRIPTION OF THE DRAWINGS

In order to illustrate the technical solutions in accordance with the embodiments of the present disclosure more clearly, the accompanying drawings to be used for describing the embodiments are introduced briefly in the following. It is apparent that the accompanying drawings in the following description are only some embodiments of the present disclosure. Persons of ordinary skill in the art can obtain other accompanying drawings in accordance with the accompanying drawings without any creative efforts.

FIG. 1 is a schematic diagram of a data synchronization system according to some embodiments of the present disclosure.

FIG. 2 to FIG. 19 are flowcharts of a data synchronization method according to some embodiments of the present disclosure.

### DETAILED DESCRIPTION OF THE EMBODIMENTS

In order to make the objectives, technical solutions, and advantages of the present disclosure clearer, the technical solutions in the embodiments of the present disclosure will be described below with reference to the drawings. It will be appreciated that the described embodiments are some rather than all of the embodiments of the present disclosure. Other embodiments conceived by those having ordinary skills in the art on the basis of the described embodiments without inventive efforts should fall within the scope of the present disclosure.

The embodiments of the present disclosure will be described in detail. Illustrations of the embodiments are shown in the accompanying drawings. The same or similar reference numerals indicate the same or similar elements or elements having the same or similar functions. The embodiments described below with reference to the accompanying drawings are illustrative, are used to explain the present disclosure, and should not be understood as limiting the present disclosure.

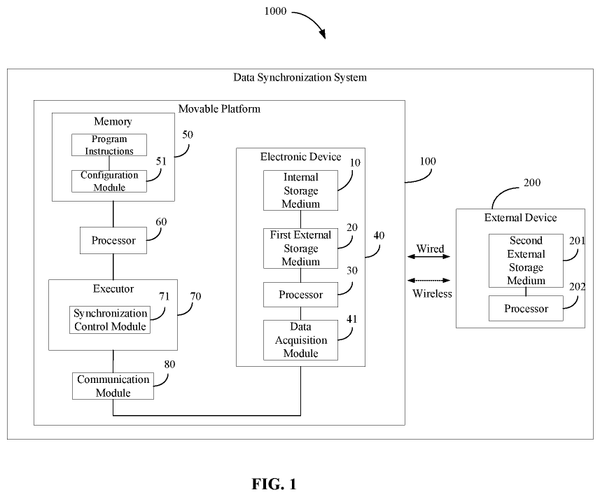

Referring to FIG. 1, an embodiment of the present disclosure provides a data synchronization system 1000. The data synchronization system 1000 includes a movable platform 100 and an external device 200.

In some embodiments, the movable platform 100 may be connected with the external device 200. More specifically, the movable platform 100 may be connected to the external device 200 through a wired connection, such as a data cable or the like. Alternatively, the movable platform 100 may also be connected to the external device 200 through a wireless connection, such as Wi-Fi, Bluetooth, mobile data network (2G/3G/4G/5G), etc.

The movable platform 100 may include unmanned aerial vehicles (UAVs), unmanned vehicles, unmanned ships, robots, or other movable devices. The external device 200 may be a portable device, such as any suitable external device, such as a mobile phone, a computer, a smart wearable device, a tablet, and a remote control. It can be understood that, in some embodiments, the external device may also be a movable platform such as a UAV, an unmanned vehicle, an unmanned ship, and a robot.

In some embodiments, the movable platform 100 may also include an electronic device 40. The electronic device 40 may be an imaging device, such as a camera or a video camera. The electronic device 40 can store data, and the electronic device 40 may include one or more of an internal storage medium 10 or a first external storage medium 20. That is, the electronic device 40 may only include the internal storage medium 10 or the first external storage medium 20. Alternatively, the electronic device 40 may include both the internal storage medium 10 and the first external storage medium 20. Further, the internal storage medium 10 may be, for example, other suitable storage medium such as an embedded multimedia card (EMMC), or a universal flash storage (UFS). The first external storage medium 20 may be, for example, other suitable storage medium such as a secure digital card (SD), or a solid-state drive (SSD).

In some embodiments, when the electronic device 40 only include the internal storage medium 10, the number of the internal storage medium 10 may be one or more. When the electronic device 40 only includes the first external storage medium 20, the number of the first external storage medium 20 may also be one or more. When the electronic device 40 simultaneously includes both the internal storage medium 10 and the first external storage medium 20, the number of the internal storage medium 10 and the first external storage medium 20 may both be one or more. When the electronic device 40 stores data, the data may be stored in the internal storage medium 10 or the first external storage medium 20 alone, or in the internal storage medium 10 and the first external storage medium 20 at the same time.

The external device 200 may also include a storage medium for storing data. The external device 200 may be similar to the electronic device 40. The external device 200 may also include only an internal storage medium, or only an external storage medium, or both the internal storage medium and the external storage medium. The number of internal storage medium and external storage medium is not limited. In this embodiment, the storage medium in the external device 200 may be collectively referred to as a second external storage medium 201.

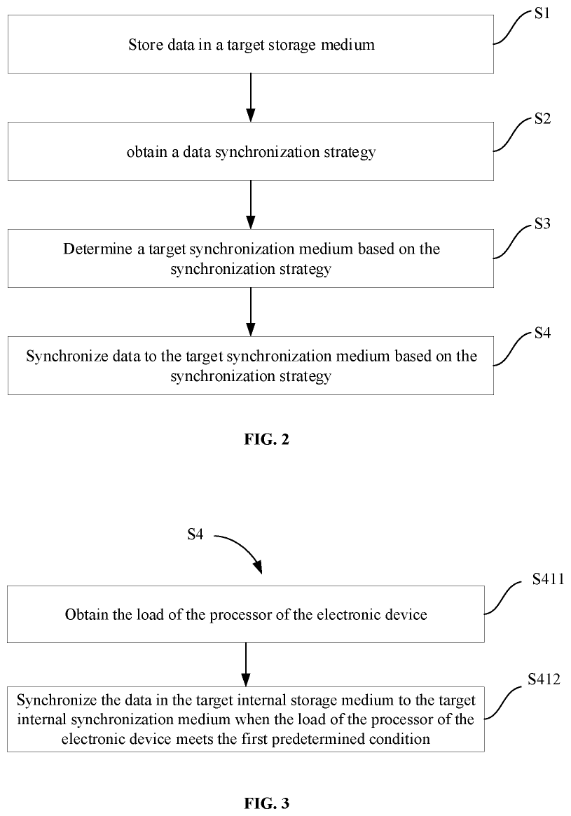

Referring to FIG. 1 and FIG. 2, an embodiment of the present disclosure also provides a method for synchronizing data in the movable platform 100. The data synchronization method will be described in detail below.

S1, storing data in a target storage medium.

S2, obtaining a data synchronization strategy.

S3, determining a target synchronization medium based on the synchronization strategy.

S4, synchronizing data to the target synchronization medium based on the synchronization strategy.

Referring to FIG. 1, the data synchronization method of the embodiments of the present disclosure can be implemented by the movable platform 100 described above. The movable platform 100 also includes a processor 60, a memory 50, and an executor 70. The memory 50 can be used to store program codes. The processor 60 can be used to call the program codes. The executor 70 can be used to execute operations indicated by the program codes. The executor 70 may be integrated in the processor 60 or placed outside the processor 60. The electronic device 40 also includes a processor 30. The processor 30 of the electronic device 40 and the processor 60 of the movable platform 100 may be the same processor or different processors, and the storage medium of the electronic device 40 and the memory 50 of the movable platform 100 may be the same storage medium or different storage mediums. If the electronic device 40 and the movable platform 100 share a processor and a storage medium, the processor 30 and the processor 60 may be the same processor at this time, and the memory 50 may be the internal storage medium 10 or the first external storage medium 20. The program codes may be stored only in the internal storage medium 10, only in the first external storage medium 20, or in the internal storage medium 10 and the first external storage medium 20 at the same time. In the embodiments of the present disclosure, the processor 30 of the electronic device 40 and the processor 60 of the movable platform 100 are the same processor, and the storage medium of the electronic device 40 and the memory 50 of the movable platform 100 are the same storage medium as an example.

The processes at S1, S2, S3, and S4 can be executed by the executor 70. That is, when the program codes are executed, the executor 70 may perform the operations of storing data in the target storage medium, obtaining the data synchronization strategy, determining a target synchronization medium based on the synchronization strategy, and synchronizing data to the target synchronization medium based on the synchronization strategy.

In some embodiments, the target storage medium may include one or more of the internal storage medium 10, the first external storage medium 20, or the second external storage medium 201. That is, the target storage medium may include only the internal storage medium 10, only the first external storage medium 20, or only the second external storage medium 201. The target storage medium may also include both the internal storage medium 10 and the first external storage medium 20 at the same time, or both the internal storage medium 10 and the second external storage medium 201 at the same time, or both the first external storage medium 20 and the second external storage medium 201 at the same time. The target storage medium may also include the internal storage medium 10, the first external storage medium 20 and the second external storage medium 201 at the same time.

The target synchronization medium may include one or more of the internal storage medium 10, the first external storage medium 20, or the second external storage medium 201. That is, the target synchronization medium may include only the internal storage medium 10, only the first external storage medium 20, or only the second external storage medium 201. The target synchronization medium may also include both the internal storage medium 10 and the first external storage medium 20 at the same time, or both the internal storage medium 10 and the second external storage medium 201 at the same time, or both the first external storage medium 20 and the second external storage medium 201 at the same time. The target synchronization medium may also include the internal storage medium 10, the first external storage medium 20, and the second external storage medium 201 at the same time.

When the electronic device 40 collects data, the processor 30 may store the collected data in the target storage medium. In some embodiments, the target storage medium may be input by the user, or may be predetermined by the movable platform 100. For example, the target storage medium may be input by the user, and the user may set the target storage medium through the physical buttons or virtual buttons on the movable platform 100. In one embodiment, the physical buttons may be any suitable physical buttons such as buttons, knobs, and dials. In another embodiment, the movable platform 100 may also include a touch screen, and the user may set the target storage medium by using the virtual buttons disposed on the touch screen.

Alternatively, in another embodiment, the user may also set the target storage medium through the physical buttons (such as buttons, knobs, and dials) or the virtual buttons (such as the touch screen, etc.) on the external device 200. The set target storage medium may be sent to the movable platform 100 for storage by the external device 200 through wired communication or wireless communication. When the target storage medium is predetermined by the movable platform 100, the manufacturer generally sets the default target storage medium before the movable platform 100 leaves the factory. If the user changes the default setting of the target storage medium when using the movable platform 100, then the target storage medium may be set by the user manually. If the user does not change the default setting of the target storage medium when using the movable platform 100, the target storage medium may be predetermined by the movable platform 100 at this time.

The data synchronization strategy may be used to indicate the target synchronization medium and the synchronization method for data synchronization from the target storage medium to the target synchronization medium. When the electronic device 40 collects data, the processor 30 may read the synchronization strategy pre-stored in the movable platform 100 to determine which storage medium the data needs to be synchronized to and the synchronization method used to synchronize the collected data, and further use the set synchronization method to synchronize the collected data to the set target synchronization medium. The synchronization strategy may also be input by the user or predetermined by the movable platform 100. If the synchronization strategy is input by the user, the user may set the synchronization strategy through the physical buttons (such as buttons, knobs, and dials) or the virtual buttons (such as the touch screen, etc.) on the movable platform 100. Alternatively, the user may also set the synchronization strategy through the physical buttons (such as buttons, knobs, and dials) or the virtual buttons (such as the touch screen, etc.) on the external device 200. The set synchronization strategy may be sent by the external device 200 to the movable platform 100 for storage through wired communication or wireless communication. When the synchronization strategy is predetermined by the movable platform 100, the default target storage medium is generally set by the manufacturer before the movable platform 100 leaves the factory. If the user changes the default setting of the synchronization strategy when using the movable platform 100, then the target storage medium may be set by the user manually. If the user does not change the default setting of the synchronization strategy when using the movable platform 100, the synchronization strategy may be predetermined by the movable platform 100 at this time.

The synchronization method in the synchronization strategy may include one or more of an active synchronization, a passive synchronization, or an asynchronous synchronization. That is, the data synchronization method may include only an active synchronization, only a passive synchronization, or only an asynchronous synchronization. Alternatively, the data synchronization method may include both the active synchronization and the passive synchronization at the same time, both the active synchronization and the asynchronous synchronization at the same time, or both the passive synchronization and the asynchronous synchronization at the same time. Alternatively, the data synchronization method may include the active synchronization, the passive synchronization, and the asynchronous synchronization at the same time. When there are multiple data synchronization methods at the same time, the movable platform 100 may need to determine a target synchronization method from the multiple synchronization methods based on the predetermined or the user-input methods.

In some embodiments, when the data synchronization method is the active synchronization, and the target storage medium and the target synchronization medium are both positioned in the electronic device 40, the electronic device 40 may not need to perform synchronization based on the received synchronization instruction input by the user when collecting data. Instead, when the electronic device 40 meets a first predetermined condition, the collected data may be actively synchronized to the target synchronization medium.

In some embodiments, the first predetermined condition may be the load of the processor 30 of the electronic device 40 being less than a first predetermined threshold. More specifically, for example, when the target storage medium is the internal storage medium 10 of the electronic device 40, and the target synchronization medium is another internal storage medium 10 of the electronic device 40, if the load of the processor 30 of the electronic device 40 is less than the first predetermined threshold, the electronic device 40 may directly synchronize the collected data to the target synchronization medium. In another example, when the target storage medium is the internal storage medium 10, and the target synchronization medium is the first external storage medium 20, if the load of the processor 30 of the electronic device 40 is less than the first predetermined threshold, the electronic device 40 may directly actively synchronize the collected data to the target synchronization medium.

In some embodiments, the movable platform 100 may be connected to the external device 200. When the data synchronization method is the active synchronization, and the target storage medium and the target synchronization medium are positioned in different devices, the electronic device 40 may not need to perform synchronization based on the received synchronization instruction input by the user when collecting data. Instead, the collected data may be actively synchronized to the target synchronization medium when the movable platform 100 and/or the external device 200 meet a second predetermined condition. In some embodiments, the second predetermined condition may include the load of the processor 30 of the electronic device 40 being less than a second predetermined threshold (the second predetermined threshold and the first predetermined threshold may be the same or different), the load of a processor 202 of the external device 200 being less than a third predetermined threshold, and the communication bandwidth of the communication link between the movable platform 100 and the external device 200 being greater than a fourth predetermined threshold. More specifically, for example, when the target storage medium is the internal storage medium 10 and/or the first external storage medium 20, and the target synchronization medium is the second external storage medium 201, if the load of the processor 30 of the electronic device 40 is less than the second predetermined threshold, the load of the processor 202 of the external device 200 if less than the third predetermined threshold, and the communication bandwidth is greater than the fourth predetermined threshold, the electronic device 40 may directly actively synchronize the collected data to the target synchronization medium. In another example, when the target storage medium is the second external storage medium 201, and the target synchronization medium is the internal storage medium 10 and/or the first external storage medium 20, if the load of the processor 30 of the electronic device 40 is less than the second predetermined threshold, the load of the processor 202 of the external device 200 if less than the third predetermined threshold, and the communication bandwidth is greater than the fourth predetermined threshold, the electronic device 40 may directly actively synchronize the collected data to the target synchronization medium. It can be understood that the second predetermined condition may also include one or any two of the load of the processor 30 of the electronic device 40 being less than the second predetermined threshold, the load of the processor 202 of the external device 200 being less than the third predetermined threshold, and the communication bandwidth of the communication link between the movable platform 100 and the external device 200 being greater than the fourth predetermined threshold. This embodiment is merely an exemplary description, which is not a limitation of the present disclosure.

In the active synchronization mode, the electronic device 40 may not need to receive the synchronization instruction input by the user before performing data synchronization, and the data synchronization process can be relatively convenient.

In some embodiments, when the data synchronization method is the passive synchronization, the electronic device 40 may not actively synchronize data to the target synchronization medium. Instead, after receiving the synchronization instruction input by the user, the electronic device 40 may synchronize the data to the target synchronization medium. The passive synchronization mode may include the following two situations. In the first situation, the synchronization strategy may include information of the target synchronization medium. At this time, the synchronization instruction input by the user may only instruct the electronic device 40 to perform the data synchronization operations. In the second situation, the synchronization strategy may not include the information of the target synchronization medium. At this time, the synchronization instruction input by the user may not only instruct the electronic device 40 to perform the data synchronization operations, but also indicate the target synchronization medium that the user wants to synchronize. For example, the user may instruct one or more of the internal storage medium 10, the first external storage medium 20, or the second external storage medium 201 as the target synchronization medium. As such, in the passive synchronization mode, the electronic device 40 may perform the data synchronization operations based on the synchronization instruction input by the user.

In the passive synchronization mode, the user may perform different synchronization operations based on different types of data (e.g., static images may be synchronized, dynamic images may not be synchronized, etc.), or different types of data may be synchronized to different storage medium (e.g., static images may be synchronized to the first external storage medium 20, dynamic images may be synchronized to the second external storage medium 201, etc.). The flexibility of data synchronization is high, which is convenient to facilitate the classification and soring of different types of data.

In some embodiments, when the data synchronization method is not synchronized, the data synchronization function of the target storage medium may be turned off. At this time, no matter whether the target synchronization medium has been set, the data cannot be synchronized to the target storage medium. In this way, in the asynchronous mode, the data has extremely high security. Further, if the user needs to synchronize data to the desired target synchronization medium in the asynchronous mode, the target synchronization medium and the target storage medium may need to be authenticated. When the authentication is successful, the data synchronization function of the target storage medium may be turned on, and the data in the target storage medium can be synchronized to the target synchronization medium. If the authentication is unsuccessful, the synchronization strategy at this time may still be out of synchronization, that is, when the authentication is unsuccessful, the data synchronization function of the target synchronization medium may remain turned off, and data cannot be synchronized to the target synchronization medium. More specifically, for example, in the asynchronous mode, the user wants to synchronize the data stored in the internal storage medium 10 to the first external storage medium 20. Then, before performing the synchronization operation, the first external storage medium 20 may need to authenticate with the internal storage medium 10. The authentication process may be a synchronization instruction input by the user to synchronize data from the internal storage medium 10 to the first external storage medium 20, the electronic device 40 prompting an identity verification window, and the electronic device 40 verifying the identity of the user. After the identity verification is passed, it may indicate that the authentication between the first external storage medium 20 and the internal storage medium 10 is successful. At this time, the data in the internal storage medium 10 can be synchronized to the first external storage medium 20. In some embodiments, the user identity verification may be a two-dimensional face recognition, three-dimensional face recognition, iris recognition, voice verification, fingerprint verification, digital password verification, pattern password verification, etc., which are not limited herein.

In the asynchronous mode, data cannot be synchronized, which can prevent the occurrence of undesired synchronization or excessive memory usage. Further, the user needs to go through an authentication process before entering the synchronization mode, which greatly ensures the data security.

Referring to FIG. 1, in the data synchronization method of the embodiments of the present disclosure, a configuration module 51 is allocated in the memory 50, a synchronization control module 71 is allocated in the executor 70, and the electronic device 40 further includes a data acquisition module 41 configured to collect data. When the target storage medium and/or the synchronization strategy are input by the user, the processor 30 may send the target storage medium and/or the synchronization strategy to the configuration module 51 for storage based on the user input. When the target storage medium and/or the synchronization strategy are predetermined, the target storage medium and/or the synchronization strategy may be directly set by the manufacturer and stored in the configuration module 51. When the executor 70 collects data, the executor 70 may first read the target storage medium and the synchronization strategy from the configuration module 51 of the memory 50. Subsequently, the executor 70 may store the collected data in the target storage medium, and the synchronization control module 71 may synchronize the collected data to the target synchronization medium based on the synchronization strategy.

In summary, in the data synchronization method, the movable platform 100, and the data synchronization system 1000 of the embodiments of the present disclosure, a data synchronization mechanism is provided between multiple storage mediums. The user can instruct the movable platform 100 to synchronize data based on the synchronization strategy by setting the synchronization strategy, which can improve the flexibility of data storage and synchronization, and improve the user experience.

Referring to FIG. 1 and FIG. 3, in some embodiments, the electronic device 40 may include a plurality of internal storage mediums 10, and the plurality of internal storage mediums 10 may include at least one target internal storage medium set as the target storage mediums, and at least one target internal synchronization medium set as the target synchronization medium. When the data synchronization mode is active synchronization, the process at S4 of synchronizing the data to the target synchronization medium based on the synchronization strategy may include the following processes.

S411, obtaining the load of the processor 30 of the electronic device 40.

S412, synchronizing the data in the target internal storage medium to the target internal synchronization medium when the load of the processor 30 of the electronic device 40 meets the first predetermined condition.

Referring to FIG. 1, the processes at S411 and S412 can both be executed by the executor 70. That is, when the program codes are being executed, the executor 70 can be used to obtain the load of the processor 30 of the electronic device 40, and synchronize the data in the target internal storage medium to the target internal synchronization medium when the load of the processor 30 of the electronic device 40 meets the first predetermined condition.

More specifically, obtaining the load of the processor 30 of the electronic device 40 may include the executor 70 reading from the processor 30. The load of the processor 30 may be understood as the number of processes currently managed and controlled by the processor 30. When the number of processes currently managed and controlled by the processor 30 is relatively large, the load of the processor 30 is relatively high, and when the number of processes currently managed and controlled by the processor 30 is relatively small, the load of the processor 30 is relatively low. After the executor 70 reads the load of the processor 30, the executor 70 may compare the load of the processor 30 with the first predetermined condition. When the load of the processor 30 is less than the first predetermined condition, the processor 30 may synchronize a part of the collected data in the target internal storage medium to the target internal synchronization medium while storing the collected data in the target internal storage medium. If the load of the processor 30 is greater than or equal to the first predetermined condition, the executor 70 may not perform the data synchronization operation, but wait until the load of the processor 30 is less than the first predetermined threshold before performing the data synchronization operation. As such, the active sharing of data of multiple internal storage medium 10 in the electronic device 40 can be realized.

Similarly, in the passive synchronization mode, if the user inputs a synchronization instruction, the executor 70 may need to perform the operation of synchronizing the collected data stored in the target internal storage medium to the target internal synchronization medium. If the load of the processor 30 is high during the synchronizing process, the executor 70 may also wait until the load of the processor 30 is less than the first predetermined condition before performing the data synchronization operation. In the asynchronous mode, if the authentication between the target internal storage medium and the target internal synchronization medium is successful, the executor 70 may need to perform the operation of synchronizing the collected data stored in the target internal storage medium to the target internal synchronization medium. If the load of the processor 30 is high during the synchronizing process, the executor 70 may also wait until the load of the processor 30 is less than the first predetermined condition before performing the data synchronization operation.

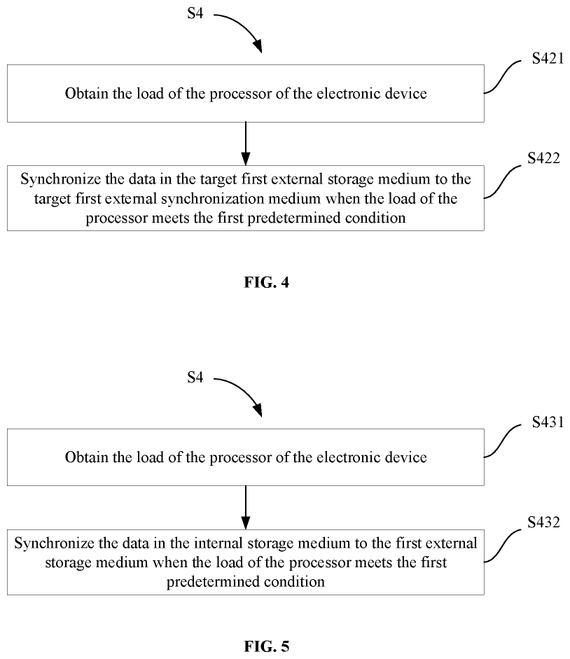

Referring to FIG. 1 and FIG. 4, in some embodiments, the electronic device 40 may include a plurality of first external storage mediums 20, and the plurality of first external storage mediums 20 may include one or more of a target first external storage medium set as a target storage medium, and one or more of a target first external synchronization medium set as a target synchronization medium. When the data synchronization mode is active synchronization, the process at S4 of synchronizing the data to the target synchronization medium based on the synchronization strategy may include the following processes.

S421, obtaining the load of the processor 30 of the electronic device 40.

S422, synchronizing the data in the target first external storage medium to the target first external synchronization medium when the load of the processor 30 meets the first predetermined condition.

Referring to FIG. 1, the processes at S421 and S422 can both be executed by the executor 70. That is, when the program codes are being executed, the executor 70 can be used to obtain the load of the processor 30 of the electronic device 40, and synchronize the data in the target first external storage medium to the target first external synchronization medium when the load of the processor 30 of the electronic device 40 meets the first predetermined condition.

More specifically, obtaining the load of the processor 30 of the electronic device 40 may include the executor 70 reading from the processor 30. The load of the processor 30 may be understood as the number of processes currently managed and controlled by the processor 30. When the number of processes currently managed and controlled by the processor 30 is relatively large, the load of the processor 30 is relatively high, and when the number of processes currently managed and controlled by the processor 30 is relatively small, the load of the processor 30 is relatively low. After the executor 70 reads the load of the processor 30, the executor 70 may compare the load of the processor 30 with the first predetermined condition. When the load of the processor 30 is less than the first predetermined condition, the processor 30 may synchronize a part of the collected data in the target first external storage medium to the target first external synchronization medium while storing the collected data in the target first external storage medium. If the load of the processor 30 is greater than or equal to the first predetermined condition, the executor 70 may not perform the data synchronization operation, but wait until the load of the processor 30 is less than the first predetermined threshold before performing the data synchronization operation. As such, the active sharing of data of multiple first external storage medium 20 in the electronic device 40 can be realized.

Similarly, in the passive synchronization mode, if the user inputs a synchronization instruction, the executor 70 may need to perform the operation of synchronizing the collected data stored in the target first external storage medium to the target first external synchronization medium. If the load of the processor 30 is high during the synchronizing process, the executor 70 may also wait until the load of the processor 30 is less than the first predetermined condition before performing the data synchronization operation. In the asynchronous mode, if the authentication between the target first external storage medium and the target first external synchronization medium is successful, the executor 70 may need to perform the operation of synchronizing the collected data stored in the target first external storage medium to the target first external synchronization medium. If the load of the processor 30 is high during the synchronizing process, the executor 70 may also wait until the load of the processor 30 is less than the first predetermined condition before performing the data synchronization operation.

Referring to FIG. 1 and FIG. 5, in some embodiments, when the target storage medium is the internal storage medium 10, and the target synchronization medium is the first external storage medium 20, if the data synchronization mode is active synchronization, the process at S4 of synchronizing the data to the target synchronization medium based on the synchronization strategy may include the following processes.

S431, obtaining the load of the processor 30 of the electronic device 40.

S432, synchronizing the data in the internal storage medium 10 to the first external storage medium 20 when the load of the processor 30 meets the first predetermined condition.

Referring to FIG. 1, the processes at S431 and S432 can both be executed by the executor 70. That is, when the program codes are being executed, the executor 70 can be used to obtain the load of the processor 30 of the electronic device 40, and synchronize the data in the internal storage medium 10 to the first external storage medium 20 when the load of the processor 30 of the electronic device 40 meets the first predetermined condition.

More specifically, obtaining the load of the processor 30 of the electronic device 40 may include the executor 70 reading from the processor 30. The load of the processor 30 may be understood as the number of processes currently managed and controlled by the processor 30. When the number of processes currently managed and controlled by the processor 30 is relatively large, the load of the processor 30 is relatively high, and when the number of processes currently managed and controlled by the processor 30 is relatively small, the load of the processor 30 is relatively low. After the executor 70 reads the load of the processor 30, the executor 70 may compare the load of the processor 30 with the first predetermined condition. When the load of the processor 30 is less than the first predetermined condition, the processor 30 may synchronize a part of the collected data in the internal storage medium 10 to the first external storage medium 20 while storing the collected data in the internal storage medium 10. If the load of the processor 30 is greater than or equal to the first predetermined condition, the executor 70 may not perform the data synchronization operation, but wait until the load of the processor 30 is less than the first predetermined threshold before performing the data synchronization operation. As such, the active sharing of data of between the internal storage medium 10 and the first external storage medium 20 in the electronic device 40 can be realized.

Similarly, in the passive synchronization mode, if the user inputs a synchronization instruction, the executor 70 may need to perform the operation of synchronizing the collected data stored in the internal storage medium 10 to the first external storage medium 20. If the load of the processor 30 is high during the synchronizing process, the executor 70 may also wait until the load of the processor 30 is less than the first predetermined condition before performing the data synchronization operation. In the asynchronous mode, if the authentication between the target internal storage medium 10 and the first external storage medium 20 is successful, the executor 70 may need to perform the operation of synchronizing the collected data stored in the internal storage medium 10 to the first external storage medium 20. If the load of the processor 30 is high during the synchronizing process, the executor 70 may also wait until the load of the processor 30 is less than the first predetermined condition before performing the data synchronization operation.

Referring to FIG. 1 and FIG. 6, in some embodiments, when the target storage medium is the first external storage medium 20, and the target synchronization medium is the internal storage medium 10, if the data synchronization mode is active synchronization, the process at S4 of synchronizing the data to the target synchronization medium based on the synchronization strategy may include the following processes.

S441, obtaining the load of the processor 30 of the electronic device 40.

S442, synchronizing the data in the first external storage medium 20 to the first internal storage medium 10 when the load of the processor 30 meets the first predetermined condition.

Referring to FIG. 1, the processes at S441 and S442 can both be executed by the executor 70. That is, when the program codes are being executed, the executor 70 can be used to obtain the load of the processor 30 of the electronic device 40, and synchronize the data in the first external storage medium 20 to the internal storage medium 10 when the load of the processor 30 of the electronic device 40 meets the first predetermined condition.

More specifically, obtaining the load of the processor 30 of the electronic device 40 may include the executor 70 reading from the processor 30. The load of the processor 30 may be understood as the number of processes currently managed and controlled by the processor 30. When the number of processes currently managed and controlled by the processor 30 is relatively large, the load of the processor 30 is relatively high, and when the number of processes currently managed and controlled by the processor 30 is relatively small, the load of the processor 30 is relatively low. After the executor 70 reads the load of the processor 30, the executor 70 may compare the load of the processor 30 with the first predetermined condition. When the load of the processor 30 is less than the first predetermined condition, the processor 30 may synchronize a part of the collected data in the first external storage medium 20 to the internal storage medium 10 while storing the collected data in the first external storage medium 20. If the load of the processor 30 is greater than or equal to the first predetermined condition, the executor 70 may not perform the data synchronization operation, but wait until the load of the processor 30 is less than the first predetermined threshold before performing the data synchronization operation. As such, the active sharing of data of between the first external storage medium 20 and the internal storage medium 10 in the electronic device 40 can be realized.

Similarly, in the passive synchronization mode, if the user inputs a synchronization instruction, the executor 70 may need to perform the operation of synchronizing the collected data stored in the first external storage medium 20 to the internal storage medium 10. If the load of the processor 30 is high during the synchronizing process, the executor 70 may also wait until the load of the processor 30 is less than the first predetermined condition before performing the data synchronization operation. In the asynchronous mode, if the authentication between the target internal storage medium 10 and the first external storage medium 20 is successful, the executor 70 may need to perform the operation of synchronizing the collected data stored in the first external storage medium 20 to the internal storage medium 10. If the load of the processor 30 is high during the synchronizing process, the executor 70 may also wait until the load of the processor 30 is less than the first predetermined condition before performing the data synchronization operation.

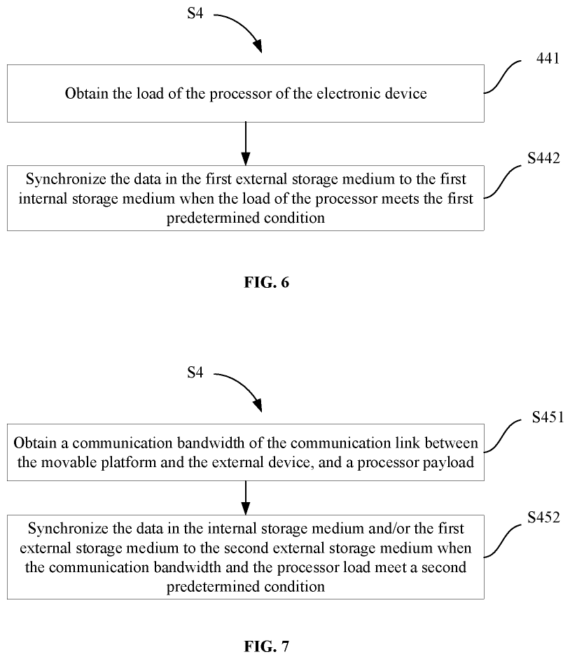

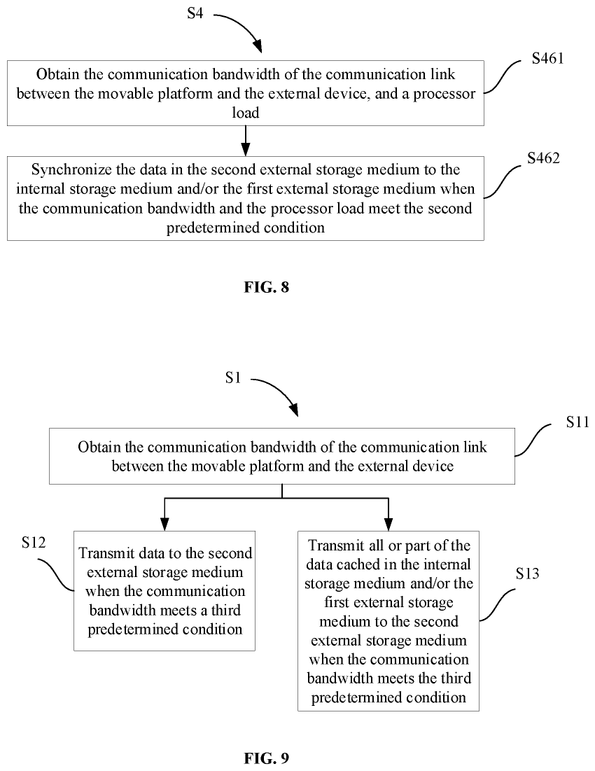

Referring to FIG. 1 and FIG. 7, in some embodiments, when the target storage medium is the internal storage medium 10 and/or the first external storage medium 20, and the target synchronization medium is the second external storage medium 201, if the data synchronization mode is active synchronization, the process at S4 of synchronizing the data to the target synchronization medium based on the synchronization strategy may include the following processes.

S451, obtaining a communication bandwidth of the communication link between the movable platform 100 and the external device 200 and a processor load, the processor load including one or more of the load of the processor 30 of the electronic device 40 or the load of the processor 202 of the external device 200.

S452, synchronizing the data in the internal storage medium 10 and/or the first external storage medium 20 to the second external storage medium 201 when the communication bandwidth and the processor load meet a second predetermined condition.

Referring to FIG. 1, the processes at S451 and S452 can both be executed by the executor 70. That is, when the program codes are being executed, the executor 70 can be used to obtain the communication bandwidth of the communication link between the movable platform 100 and the external device 200 and the processor load, the processor load including one or more of the load of the processor 30 of the electronic device 40 or the load of the processor 202 of the external device 200; and synchronize the data in the internal storage medium 10 and/or the first external storage medium 20 to the second external storage medium 201 when the communication bandwidth and the processor load meet the second predetermined condition.

In some embodiments, the target storage medium being the internal storage medium 10 and/or the first external storage medium 20, and the target synchronization medium being the second external storage medium 201 may include the following three data synchronization scenarios. In the first data synchronization scenario, the data collected by the electronic device 40 may be stored in the internal storage medium 10 and synchronized to the second external storage medium 201. In the second data synchronization scenario, the data collected by the electronic device 40 may be stored in the first external storage medium 20 and synchronized to the second external storage medium 201. In the third data synchronization scenario, the data collected by the electronic device 40 may be partly stored in the internal storage medium 10 and partly stored in the first external storage medium 20, and the part of the data stored in the internal storage medium 10 and the part of the data stored in the first external storage medium 20 may be synchronized to the second external storage medium 201.

In some embodiments, the processor load including one or more of the load of the processor 30 of the electronic device 40 or the load of the processor 202 of the external device 200 may include the following three situations. In the first situation, only the load of the processor 30 of the electronic device 40 may be considered. In the second situation, only the load of the processor 202 of the external device 200 may be considered. In the third situation, both the load of the processor 30 of the electronic device 40 and the load of the processor 202 of the external device 200 may be considered. In the embodiments of the present disclosure, when synchronizing the data of the internal storage medium 10 and/or the first external storage medium 20 to the second external storage medium 201, the load of the processor 30 of the electronic device 40 and the load of the processor 202 of the external device 200 may be comprehensively considered.

The communication bandwidth of the communication link between the movable platform 100 and the external device 200 may be obtained based on a test signal. That is, the external device 200 may send a test signal to the movable platform 100, and a communication module 80 of the movable platform 100 may send the test signal to the processor 30 after receiving the test signal. The processor 30 may calculate the communication bandwidth of the communication link based on the test signal. The executor 70 may then read the communication bandwidth from the processor 30.

In one embodiment, obtaining the load of the processor 202 of the external device 200 may be the communication module of the external device 200 sending the load of the processor 202 of the external device 200 to the movable platform 100. The communication module 80 of the movable platform 100 may receive the load of the processor 202 and send the load of the processor 202 to the processor 30, which can be read from the processor 30 by the executor 70. The load of the external device 200 may be understood as the number of processes currently managed and controlled by the processor 202. When the number of processes currently managed and controlled by the processor 202 is relatively large, the load of the processor 202 is relatively high, and when the number of processes currently managed and controlled by the processor 202 is relatively small, the load of the processor 202 is relatively low. Obtaining the load of the processor 30 of the electronic device 40 may include the executor 70 reading from the processor 30. The load of the processor 30 may be understood as the number of processes currently managed and controlled by the processor 30. When the number of processes currently managed and controlled by the processor 30 is relatively large, the load of the processor 30 is relatively high, and when the number of processes currently managed and controlled by the processor 30 is relatively small, the load of the processor 30 is relatively low. After the executor 70 reads the load of the processor 30, the load of the processor 202, and the communication bandwidth, the executor 70 may compare the load of the processor 30 with the second predetermined threshold, the load of the processor 202 with a third predetermined threshold, and the communication bandwidth with a fourth predetermined threshold. When the load of the processor 30 is less than the second predetermined threshold, the load of the processor 202 is less than the third predetermined threshold, and the communication bandwidth is greater than the fourth predetermined threshold, the executor 70 may also synchronize a part of the collected data in the internal storage medium 10 and/or the first external storage medium 20 to the second external storage medium 201 while storing the collected in the internal storage medium 10 and/or the first external storage medium 20.

Further, any one of the load of the processor 30 of the electronic device 40, the load of the processor 202 of the external device 200, and the communication bandwidth does not meet the predetermined condition, then the executor 70 may not perform the data synchronization, but wait until the load of the processor 30 is less than the second predetermined threshold, the load of the processor 202 is less than the third predetermined threshold, and the communication bandwidth is greater than the fourth predetermined threshold before performing the data synchronization operation. As such, the active sharing of data of between the electronic device 40 and the external device 200 can be realized. In other embodiments, the second predetermined condition may also include only one or a combination of the load of the processor 30 of the electronic device 40, the load of the processor 202 of the external device 200, and the communication bandwidth, which is not limited herein.

Similarly, in the passive synchronization mode, if the user inputs a synchronization instruction, the executor 70 may need to perform the operation of synchronizing the collected data stored in the internal storage medium 10 and/or the first external storage medium 20 to the second external storage medium 201. If any one of the load of the processor 30, the load of the processor 202, and the communication bandwidth does not meet the second predetermined condition, the executor 70 may also wait until the load of the processor 30 is less than the second predetermined threshold, the load of the processor 202 is less than the third predetermined threshold, and the communication bandwidth is greater than the fourth predetermined threshold before performing the data synchronization operation. In the asynchronous mode, if the authentication between the internal storage medium 10 and/or the first external storage medium 20 and the second external storage medium 201 is successful, the executor 70 may need to perform the operation of synchronizing the collected data stored in the internal storage medium 10 and/or the first external storage medium 20 to the second external storage medium 201. If any one of the load of the processor 30, the load of the processor 202, and the communication bandwidth does not meet the second predetermined condition, the executor 70 may also wait until the load of the processor 30 is less than the second predetermined threshold, the load of the processor 202 is less than the third predetermined threshold, and the communication bandwidth is greater than the fourth predetermined threshold before performing the data synchronization operation.

Referring to FIG. 1 and FIG. 8, in some embodiments, when the target storage medium is the second external storage medium 201, and the target synchronization medium is the internal storage medium 10 and/or the first external storage medium 20, if the data synchronization mode is active synchronization, the process at S4 of synchronizing the data to the target synchronization medium based on the synchronization strategy may include the following processes.

S461, obtaining the communication bandwidth of the communication link between the movable platform 100 and the external device 200 and a processor load, the processor load including one or more of the load of the processor 30 of the electronic device 40 or the load of the processor 202 of the external device 200.

S462, synchronizing the data in the second external storage medium 201 to the internal storage medium 10 and/or the first external storage medium 20 when the communication bandwidth and the processor load meet the second predetermined condition.

Referring to FIG. 1, the processes at S461 and S462 can both be executed by the executor 70. That is, when the program codes are being executed, the executor 70 can be used to obtain the communication bandwidth of the communication link between the movable platform 100 and the external device 200 and a processor load, the processor load including one or more of the load of the processor 30 of the electronic device 40 or the load of the processor 202 of the external device 200; and synchronize the data in the second external storage medium 201 to the internal storage medium 10 and/or the first external storage medium 20 when the communication bandwidth and the processor load meet the second predetermined condition.

In some embodiments, the target storage medium being the second external storage medium 201, and the target synchronization medium being the internal storage medium 10 and/or the first external storage medium 20 may include the following three data synchronization scenarios. In the first data synchronization scenario, the data collected by the electronic device 40 may be stored in the second external storage medium 201 and synchronized to the internal storage medium 10. In the second data synchronization scenario, the data collected by the electronic device 40 may be stored in the second external storage medium 201 and synchronized to the first external storage medium 20. In the third data synchronization scenario, the data collected by the electronic device 40 may be stored in the second external storage medium 201, and synchronized to the internal storage medium 10 and the first external storage medium 20 at the same time.

In some embodiments, the processor load including one or more of the load of the processor 30 of the electronic device 40 or the load of the processor 202 of the external device 200 may include the following three situations. In the first situation, only the load of the processor 30 of the electronic device 40 may be considered. In the second situation, only the load of the processor 202 of the external device 200 may be considered. In the third situation, both the load of the processor 30 of the electronic device 40 and the load of the processor 202 of the external device 200 may be considered at the same time. In the embodiments of the present disclosure, when synchronizing the data of the second external storage medium 201 to the internal storage medium 10 and/or the first external storage medium 20, the load of the processor 30 of the electronic device 40 and the load of the processor 202 of the external device 200 may be comprehensively considered.

The communication bandwidth of the communication link between the movable platform 100 and the external device 200 may be obtained based on a test signal. That is, the external device 200 may send a test signal to the movable platform 100, and a communication module 80 of the movable platform 100 may send the test signal to the processor 30 after receiving the test signal. The processor 30 may calculate the communication bandwidth of the communication link based on the test signal. The executor 70 may then read the communication bandwidth from the processor 30.

In one embodiment, obtaining the load of the processor 202 of the external device 200 may be the communication module of the external device 200 sending the load of the processor 202 of the external device 200 to the movable platform 100. The communication module 80 of the movable platform 100 may receive the load of the processor 202 and send the load of the processor 202 to the processor 30, which can be read from the processor 30 by the executor 70. The load of the external device 200 may be understood as the number of processes currently managed and controlled by the processor 202. When the number of processes currently managed and controlled by the processor 202 is relatively large, the load of the processor 202 is relatively high, and when the number of processes currently managed and controlled by the processor 202 is relatively small, the load of the processor 202 is relatively low. Obtaining the load of the processor 30 of the electronic device 40 may include the executor 70 reading from the processor 30. The load of the processor 30 may be understood as the number of processes currently managed and controlled by the processor 30. When the number of processes currently managed and controlled by the processor 30 is relatively large, the load of the processor 30 is relatively high, and when the number of processes currently managed and controlled by the processor 30 is relatively small, the load of the processor 30 is relatively low. After the executor 70 reads the load of the processor 30, the load of the processor 202, and the communication bandwidth, the executor 70 may compare the load of the processor 30 of the electronic device 40 with the second predetermined threshold, the load of the processor 202 of the external device 200 with the third predetermined threshold, and the communication bandwidth with the fourth predetermined threshold. When the load of the processor 30 of the electronic device 40 is less than the second predetermined threshold, the load of the processor 202 of the external device 200 is less than the third predetermined threshold, and the communication bandwidth is greater than the fourth predetermined threshold, the executor 70 may also control the communication module 80 of the movable platform 100 to receive data sent by the external device 200, and store the data in the internal storage medium 10 and/or the first external storage medium 20.

Further, any one of the load of the processor 30 of the electronic device 40, the load of the processor 202 of the external device 200, and the communication bandwidth does not meet the predetermined condition, then the executor 70 may not control the communication module 80 of the movable platform 100 to receive the data sent by the external device 200, but wait until the load of the processor 30 is less than the second predetermined threshold, the load of the processor 202 is less than the third predetermined threshold, and the communication bandwidth is greater than the fourth predetermined threshold before controlling the communication module 80 of the movable platform 100 to receive the data sent by the external device 200 and storing it, thereby completing the data synchronization operation. As such, the active sharing of data of between the electronic device 40 and the external device 200 can be realized. In other embodiments, the second predetermined condition may also include only one or a combination of the load of the processor 30 of the electronic device 40, the load of the processor 202 of the external device 200, and the communication bandwidth, which is not limited herein.

Similarly, in the passive synchronization mode, if the user inputs a synchronization instruction, the executor 70 may need to perform the operation of synchronizing the collected data stored in the second external storage medium 201 to the internal storage medium 10 and/or the first external storage medium 20. If any one of the load of the processor 30 of the electronic device 40, the load of the processor 202 of the external device 200, and the communication bandwidth does not meet the second predetermined condition, the executor 70 may also wait until the load of the processor 30 of the electronic device 40 is less than the second predetermined threshold, the load of the processor 202 of the external device 200 is less than the third predetermined threshold, and the communication bandwidth is greater than the fourth predetermined threshold before controlling the communication module 80 to receive data to complete the data synchronization operation. In the asynchronous mode, if the authentication between the internal storage medium 10 and/or the first external storage medium 20 and the second external storage medium 201 is successful, the executor 70 may need to perform the operation of synchronizing the collected data stored in the second external storage medium 201 to the internal storage medium 10 and/or the first external storage medium 20. If any one of the load of the processor 30 of the electronic device 40, the load of the processor 202 of the external device 200, and the communication bandwidth does not meet the second predetermined condition, the executor 70 may also wait until the load of the processor 30 of the electronic device 40 is less than the second predetermined threshold, the load of the processor 202 of the external device 200 is less than the third predetermined threshold, and the communication bandwidth is greater than the fourth predetermined threshold before controlling the communication module 80 to receive data to complete the data synchronization operation.

Referring to FIG. 1 and FIG. 9, in some embodiments, when the target storage medium is the second external storage medium 201, the process at S1 of storing data in the target storage medium may include the following processes.

S11, obtaining the communication bandwidth of the communication link between the movable platform 100 and the external device 200.

S12, transmitting data to the second external storage medium 201 when the communication bandwidth meets a third predetermined condition.

Referring to FIG. 1, the processes at S11 and S12 can both be executed by the executor 70. That is, when the program codes are being executed, the executor 70 can be used to obtain the communication bandwidth of the communication link between the movable platform 100 and the external device 200; and transmit data to the second external storage medium 201 when the communication bandwidth meets the third predetermined condition

More specifically, when the target storage medium is the second external storage medium 201, the data collected by the electronic device 40 may be generally directly stored in the second external storage medium 201, instead of being stored in the internal storage medium 10 or the first external storage medium 20. However, if in the process of collecting data by the electronic device 40, the communication bandwidth of the communication link between the movable platform 100 and the external device 200 does not meet the third predetermined condition, for example, less than a fifth predetermined threshold (the fifth predetermined threshold may be equal to or different from the fourth predetermined threshold), then the data collected by the electronic device 40 may be cached in the internal storage medium 10 and/or the first external storage medium 20 in advance. For example, assume that the data collected by the electronic device 40 may be data, and data may be composed of data1 and data2, where data1 may refer to the data directly stored in the second external storage medium 201 during the data collection process, and data2 may refer to the data first cached in the internal storage medium 10 and/or the first external storage medium 20 due to the limitation of communication bandwidth during the data collection process. The data2 may be all cached in the internal storage medium 10, or all cached in the first external storage medium 20, or partially cached in the internal storage medium 10 and partially cached in the first external storage medium 20.

Further, referring to FIG. 9, the process at S1 of storing data in the target storage medium may include the following process.

S13, transmitting all or part of the data cached in the internal storage medium 10 and/or the first external storage medium 20 to the second external storage medium 201 when the communication bandwidth meets the third predetermined condition.

Referring to FIG. 1, the process at S13 can both be executed by the executor 70. That is, when the program codes are being executed, the executor 70 can be used to transmit all or part of the data cached in the internal storage medium 10 and/or the first external storage medium 20 to the second external storage medium 201 when the communication bandwidth meets the third predetermined condition.

More specifically, since the target storage medium is the second external storage medium 201, the data may be first cached in the internal storage medium 10 and/or the first external storage medium 20 due to the limitation of the communication bandwidth. When the subsequent communication bandwidth is greater than or equal to the fifth predetermined threshold, the executor 70 may perform an operation of incremental data transmission. If the complete data fails to be directly stored in the second external storage medium 201, but is all cached in the internal storage medium 10 and/or the first external storage medium 20, the executor 70 may transmit the complete data cached in the internal storage medium 10 and/or the first external storage medium 20 to the second external storage medium 201. If only part of the data cannot be directly stored in the second external storage medium 201, that is, the data data2 is cached in the internal storage medium 10 and/or the first external storage medium 20, the executor 70 may transmit the data data2 cached in the internal storage medium 10 and/or the first external storage medium 20 to the second external storage medium 201. After the transmission ends, the data cached in the internal storage medium 10 and/or the first external storage medium 20 can be deleted or retained.

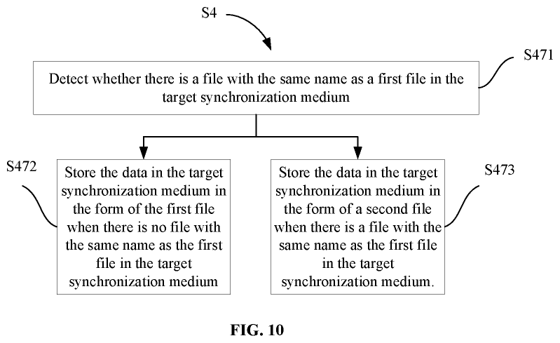

Referring to FIG. 1 and FIG. 10, in some embodiments, data may be stored in the target storage medium in the form of a first file, and the process at S4 of synchronizing the data to the target synchronization medium based on the synchronization strategy may include the following processes.

S471, detecting whether there is a file with the same name as a first file in the target synchronization medium.

S472, storing the data in the target synchronization medium in the form of the first file when there is no file with the same name as the first file in the target synchronization medium.

S473, storing the data in the target synchronization medium in the form of a second file when there is a file with the same name as the first file in the target synchronization medium.

Referring to FIG. 1, the processes at S471, S472, and S473 can be executed by the executor 70. That is, when the program codes are being executed, the executor 70 can be used to detect whether there is a file with the same name as the first file in the target synchronization medium; store the data in the target synchronization medium in the form of the first file when there is no file with the same name as the first file in the target synchronization medium; and store the data in the target synchronization medium in the form of a second file when there is a file with the same name as the first file in the target synchronization medium.

More specifically, the name of the first file may be the same as or different from the name of the second file. When the name of the first file is different from the name of the second file, when the data collected by the electronic device 40 is synchronized to the target synchronization medium, the first file may be stored in the same directory as the second file, or the first file may be stored in a directory different from the second file. When the name of the first file is the same as the name of the second file, the target synchronization medium may include two or more storage directories at this time. The storage location of the first file and the second file with the same name as the first file may be stored in a different storage directory. As such, during the data synchronization process, the data already stored in the target synchronization medium can be prevented from being overwritten by the data currently to be synchronized, which can cause the problem of losing the stored data.

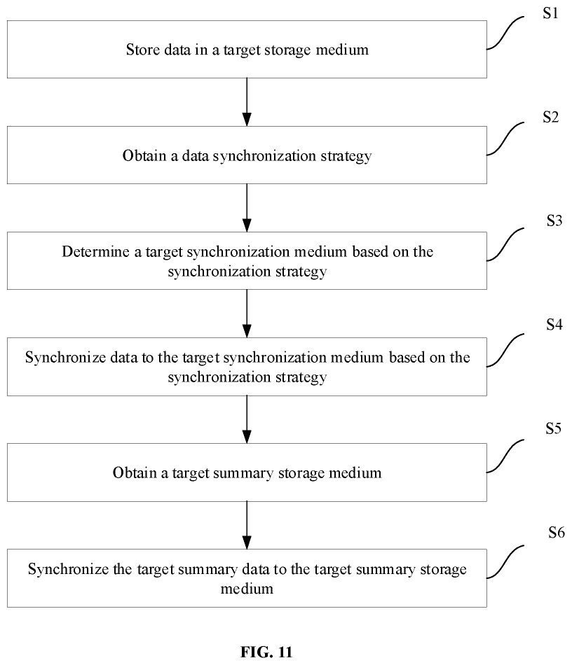

Referring to FIG. 11, in some embodiments, the data storage method of the embodiments of the present disclosure may further include the following processes.

S5, obtaining a target summary storage medium, the target summary storage medium being one or more of the internal storage medium 10, the first external storage medium 20, and the second external storage medium 201.

S6, synchronizing the target summary data to the target summary storage medium.

Referring to FIG. 1, the processes at S45 and S6 can be executed by the executor 70. That is, when the program codes are being executed, the executor 70 can be used to obtain the target summary storage medium, and synchronize the target summary data to the target summary storage medium.

In some embodiments, the target summary storage medium may be one or more of the internal storage medium 10, the first external storage medium 20, or the second external storage medium 201. More specifically, the target summary storage medium may be any one of the internal storage medium 10, the first external storage medium 20, and the second external storage medium 201. Alternatively, the target summary storage medium may include the internal storage medium 10 and the first external storage medium 20 at the same time, the first external storage medium 20 and the second external storage medium 201 at the same time, and the internal storage medium 10 and the second external storage medium 201 at the same time. Alternatively, the target summary storage medium may include the internal storage medium 10, the first external storage medium 20, and the second external storage medium 201 at the same time. In the process of data summary, part of the data not stored in the target summary storage medium can be summarized, or all data not stored in the target summary storage medium can be summarized.

The target summary storage medium may be the same as or different from the target storage medium, and the target summary storage medium may be the same as or different from the target synchronization medium, which is not limited in the embodiments of the present disclosure.

Further, the target summary data may include data stored in the target storage medium and data synchronized to the target synchronization medium. In some embodiments, the data stored in the target storage medium and the data synchronized to the target synchronization medium may be all or partly the same, or they may all be different. More specifically, when the data stored in the target storage medium is the same as the data synchronized to the target synchronization medium, all the data in the target storage medium may be synchronized to the target synchronization medium at this time, and the data in the synchronized target storage medium may not be deleted. At this time, the target summary data may only summarize the data stored in the target storage medium, or only summarized the data synchronized to the target synchronization medium.

When the data stored in the target storage medium is the same as the part of the data synchronized to the target synchronization medium, in one embodiment, the target storage medium may include the stored original data and data directly obtained from the electronic device 40. In some embodiments, the data directly obtained from the electronic device 40 may be synchronized to the target synchronization medium, but the original data may not be synchronized to the target synchronization medium. At this time, the target summary data may include the original data not synchronized to the target synchronization medium and the data in the target synchronization medium.

When the data stored in the target storage medium is different from the data synchronized to the target synchronization medium, in one embodiment, after the data directly obtained from the electronic device 40 is synchronized to the target synchronization medium, the synchronized data in the target storage medium may be deleted, and only the original data that is not synchronized to the target synchronization medium may be retained in the target storage medium. At this time, the data stored in the target storage medium may be completely different from the data synchronized to the target synchronization medium, and the target summary data may include the original data that is not synchronized to the target synchronization medium and the data in the target synchronization medium.

Further, a management file can be established in the target summary medium to mark the summarized data, such that the summarized data can be quickly distinguished from the un-summarized data during the summary, which can speed up the data summary process and avoid repeated summary. In some embodiments, it is also possible to create a management file in the target storage medium or the target synchronization medium to mark the synchronized data, such that synchronized data can be quickly distinguished from the unsynchronized data during summary to void repeated summary.

In some embodiments, the target summary medium may be set by the user, or it may be predetermined.

When the target summary medium is set by the user, the user may set the target summary medium through physical buttons or virtual buttons. For example, assume that the electronic device only includes one internal storage medium 10 and one first external storage medium 20, the user sets, the target summary medium as the second external storage medium 201 at a certain time t, then after the user sets the target summary medium, the user may not need to further specify the target summary data. At this time, the executor 70 may summarize all the data stored in the internal storage medium 10 and the first external storage medium 20 that have not been summarized and synchronized to the second external storage medium 201 before time t into the second external storage medium 201. Alternatively, the user may also further specify the target summary data. At this time, the executor 70 may summarize the target summary data specified by the user into the second external storage medium 201. As such, the target summary medium for storing summary data and the type of summary data can be selected by the user, and the flexibility of data summary is improved.

When the target summary medium is predetermined, after the electronic device 40 receives the data summary instruction input by the user, the executor 70 may directly summarize the data not stored in the target summary medium into the target summary medium. If the target summary data is further specified after the data summary instruction input by the user, the executor 70 may summarize the target summary data specified by the user into the second external storage medium 201. As such, by predetermining the target summary medium, the user's operation of setting target summary medium in the data summary process can be eliminated, and the data summary process is more convenient.

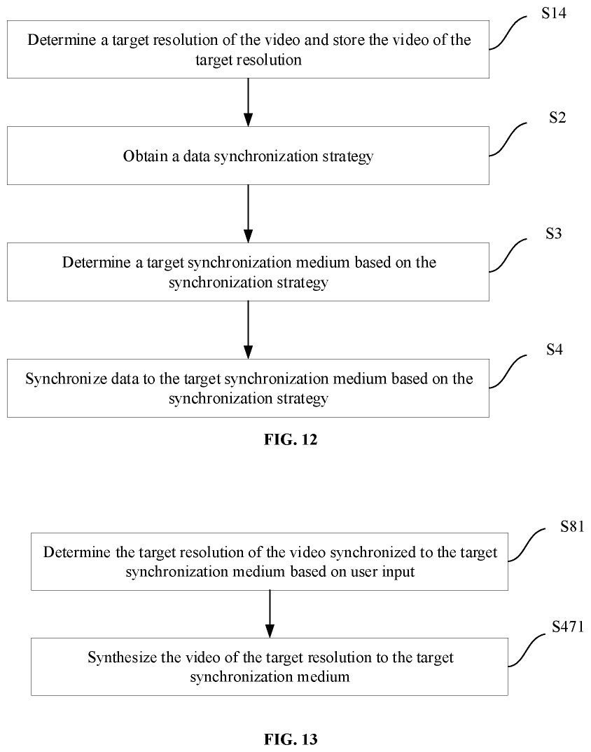

Referring to FIG. 1 and FIG. 12, in some embodiments, when the data is a video, the video may include a variety of predetermined resolution videos. The process at S1 of storing data in the target storage medium may include the following process.

S14, determining a target resolution of the video and storing the video of the target resolution, the target resolution being one or more of a plurality of predetermined resolutions.

Referring to FIG. 1, in some embodiments, the process at S14 can be executed by the executor 70. That is, when the program codes are being executed, the executor 70 can be used to determine the target resolution of the video and store the target resolution video, where the target resolution may be one or more of a plurality of predetermined resolutions.

More specifically, the predetermined resolutions may include a first resolution, a second resolution, a third resolution, a fourth resolution, a fifth resolution, etc. in descending order of resolution, and the number of predetermined resolutions is not limited herein. In the embodiments of the present disclosure, there are two predetermined resolution videos, namely the high-resolution video and the low-resolution video. In some embodiments, the high-resolution and the low-resolution may be determined by a resolution limit value. Videos with a resolution greater than a first resolution threshold may be the high-resolution videos, videos with a resolution less than a second resolution threshold may be the low-resolution videos, and the first resolution threshold may be greater than or equal to the second resolution threshold. The storage of high-resolution videos may take up more storage space and more communication bandwidth during transmission. The storage of low-resolution videos may take up less storage space and less communication bandwidth during transmission.

It can be understood that the high-resolution and low-resolution may be related to the performance of the electronic device 40 itself. For example, in one embodiment, the electronic device may support both 4K and 1080P videos. At this time, 4K is the high-resolution and 1080P is the low-resolution. In another embodiment, the electronic device may support both 1080P and 720P videos. At this time, 1080P is the high-resolution and 720P is the low-resolution. This embodiment is merely an example of the predetermined resolution, which is not limited in the embodiments of the present disclosure.

When the electronic device 40 collects data, the executor 70 may store the video based on the predetermined target resolution of the video to be stored. For example, the predetermined target resolution video may be a high-resolution video, and when the electronic device 40 collects data, the executor 70 may store the high-resolution video in the target storage medium. In another example, the predetermined target resolution video may be a low-resolution video, and when the electronic device 40 collects data, the executor 70 may store the low-resolution video in the target storage medium. In another example, the predetermined target resolution video may be a high-resolution video and a low-resolution video, and when the electronic device 40 collects data, the executor 70 may simultaneously store the high-resolution video and the low-resolution video in the target storage medium. Storing videos of multiple predetermined resolutions can facilitate subsequent operations based on the videos of different resolutions.

Referring to FIG. 13, in some embodiments, when storing videos of multiple predetermined resolutions at the same time, the data synchronization method of the embodiments of the present disclosure may further include the following processes.

S81, determining the target resolution of the video synchronized to the target synchronization medium based on user input.

The process at S4 of synchronizing the data to the target synchronization medium based on the synchronization strategy may include the following process.

S471, synthesizing the video of the target resolution to the target synchronization medium.

Referring to FIG. 1, the processes at S81 and S471 can be executed by the executor 70. That is, when the program codes are being executed, the executor 70 can be used to determine the target resolution of the video synchronized to the target synchronization medium based on user input, and synthesize the video of the target resolution to the target synchronization medium.

More specifically, the user may set the target resolution of the video through physical buttons or virtual buttons. In this way, during the video synchronization process, the executor 70 may synchronize the video of the target resolution stored in the target storage medium to the target synchronization medium. For example, the target resolution of the video set by the user may be high-resolution. During the video synchronization process, the executor 70 may synchronize the high-resolution video stored in the target storage medium to the target synchronization medium. In another example, the target resolution of the video set by the user may include both high-resolution and low-resolution. During the video synchronization process, the executor 70 may synchronize the high-resolution video and the low-resolution video stored in the target storage medium to the target synchronization medium. By allowing the user to select the video of the target resolution for synchronization, the flexibility of the video synchronization operation and the user experience can be improved.

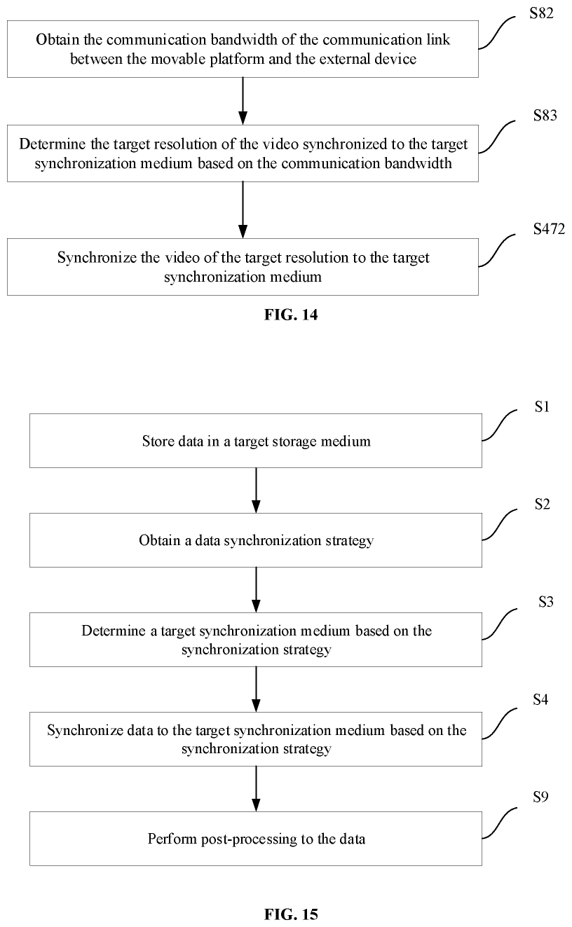

Alternatively, referring to FIG. 14, in some embodiments, when storing videos of multiple predetermined resolutions at the same time, the data synchronization method of the embodiments of the present disclosure may further include the following processes.

S82, obtaining the communication bandwidth of the communication link between the movable platform 100 and the external device 200.

S83, determining the target resolution of the video synchronized to the target synchronization medium based on the communication bandwidth.

The process at S4 of synchronizing the data to the target synchronization medium based on the synchronization strategy may include the following process.

S472, synchronizing the video of the target resolution to the target synchronization medium.

Referring to FIG. 1, in some embodiments, the processes at S82, S83, and S472 can be executed by the executor 70. That is, when the program codes are being executed, the executor 70 can be used to obtain the communication bandwidth of the communication link between the movable platform 100 and the external device 200, determine the target resolution of the video synchronized to the target synchronization medium based on the communication bandwidth, and synchronize the video of the target resolution to the target synchronization medium.

More specifically, the target resolution of the video may be determined by the communication bandwidth of the communication link between the movable platform 100 and the external device 200. At the initial moment of video synchronization, if the communication bandwidth can meet the transmission of high-resolution video, the 70 may synchronize the high-resolution video stored in the target storage medium to the target synchronization medium. If the communication bandwidth cannot meet the transmission of high-resolution video, the 70 may synchronize the low-resolution video stored in the target storage medium to the target synchronization medium. As such, the resolution of the synchronized video can be adjusted adaptively without the user's manual setting, which is convenient for the user's operation.

Referring to FIG. 1 and FIG. 15, in some embodiments, the data synchronization method of the embodiments of the present disclosure may further include the following process.

S9, performing post-processing to the data.

Referring to FIG. 1, in some embodiments, the process at S9 can be executed by the executor 70. That is, when the program codes are being executed, the executor 70 can be used to perform post-processing to the data.

In some embodiments, the post-processing may include one or more of playback, editing, sharing, or backup. It can be understood that this embodiment is merely an example, and the post-processing may also include other suitable post-processing, which is not limited herein.

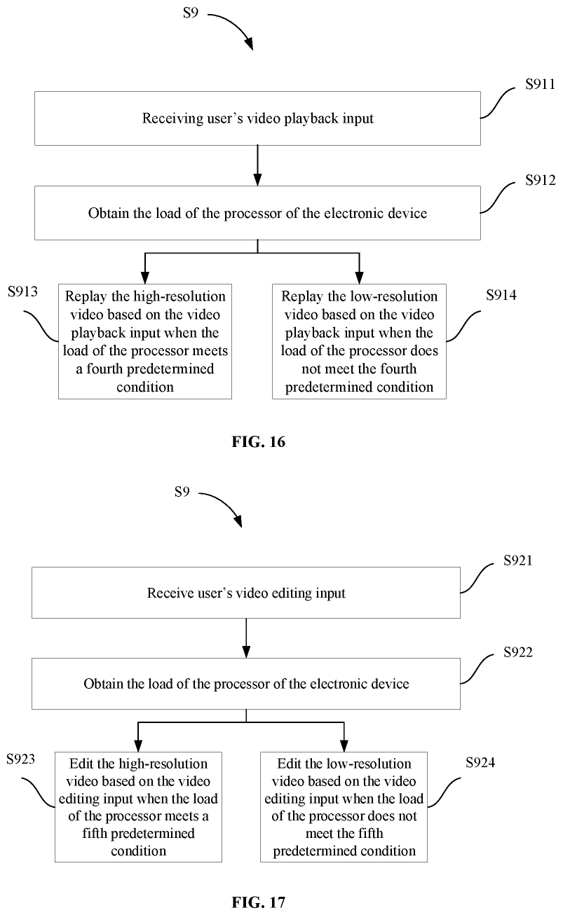

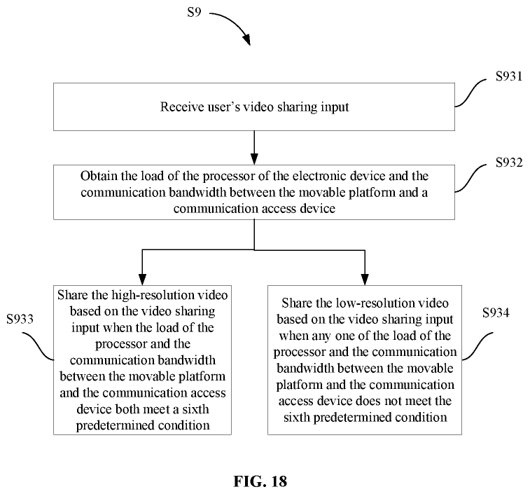

More specifically, referring to FIG. 1 and FIG. 16, when the post-processing is the playback of the data, the process at S9 of performing post-processing to the data may include the following processes.

S911, receiving user's video playback input.

S912, obtaining the load of the processor 30 of the electronic device 40.

S913, replaying the high-resolution video based on the video playback input when the load of the processor 30 meets a fourth predetermined condition.

S914, replaying the low-resolution video based on the video playback input when the load of the processor 30 does not meet the fourth predetermined condition.

Referring to FIG. 1, in some embodiments, the processes at S911, S912, S913, and 914 can be executed by the executor 70. That is, when the program codes are being executed, the executor 70 can be used to receive user's video playback input, obtain the load of the processor 30 of the electronic device 40, replay the high-resolution video based on the video playback input when the load of the processor 30 meets a fourth predetermined condition, and replaying the low-resolution video based on the video playback input when the load of the processor 30 does not meet the fourth predetermined condition.

More specifically, the user may enter the video playback input instruction through physical buttons or virtual buttons. After the electronic device 40 receives the user's video playback input instruction, the executor 70 may obtain the load of the processor 30 of the electronic device 40. If the load of the processor 30 is less than a sixth predetermined threshold at this time, the executor 70 may control the electronic device 40 to play back the high-resolution video. If the load of the processor 30 is greater than or equal to the sixth predetermined threshold at this time, the executor 70 may control the electronic device 40 to play back the low-resolution video. It can be understood that during the video playback, the processor 30 may need to perform video decoding operations. At this time, if the load of the processor 30 is high, the decoding of the high-resolution video may be relatively slow, and the decoding of the low-resolution video may be relatively fast. At this time, the low-resolution video should be played back, such that the user can watch a smooth video with freezing moments. If the load of the processor 30 is low, the processor 30 may have sufficient processing capacity to quickly decode the high-resolution video. At this time, the electronic device 40 can play back the high-resolution video, and the user can also watch a smooth video. In this way, based on the load of the processor 30, the video of the target resolution can be adaptively selected for playback, and the user experience can be improved. It can be understood that the sixth predetermined threshold of the load of the processor 30 may be equal to the first predetermined threshold, or may be different from the first predetermined threshold, which is not limited in the embodiments of the present disclosure.

Referring to FIG. 1 and FIG. 17, when the post-processing is the editing of the data, the process at S9 of performing post-processing to the data may include the following processes.

S921, receiving user's video editing input.

S922, obtaining the load of the processor 30 of the electronic device 40.

S923, editing the high-resolution video based on the video editing input when the load of the processor 30 meets a fifth predetermined condition.

S924, editing the low-resolution video based on the video editing input when the load of the processor 30 does not meet the fifth predetermined condition.

Referring to FIG. 1, in some embodiments, the processes at S921, S922, S923, and 924 can be executed by the executor 70. That is, when the program codes are being executed, the executor 70 can be used to receive user's video editing input, obtain the load of the processor 30 of the electronic device 40, edit the high-resolution video based on the video editing input when the load of the processor 30 meets a fifth predetermined condition, and edit the low-resolution video based on the video editing input when the load of the processor 30 does not meet the fifth predetermined condition.

More specifically, the user may enter the video editing input instruction through physical buttons or virtual buttons. After the electronic device 40 receives the user's video editing input instruction, the executor 70 may obtain the load of the processor 30 of the electronic device 40. If the load of the processor 30 is less than a seventh predetermined threshold at this time, the executor 70 may control the electronic device 40 to edit the high-resolution video. If the load of the processor 30 is greater than or equal to the seventh predetermined threshold at this time, the executor 70 may control the electronic device 40 to edit the low-resolution video. It can be understood that during the video editing process, the editing of high-resolution video may require more processing space of the processor 30. At this time, if the load of the processor 30 is high, the editing process of high-resolution video may be relatively slow, while the editing process of the low-resolution video may be relatively fast. At this time, the low-resolution video should be edited to speed up the video editing process and reduce the video editing time. If the load of the processor 30 is low, the processor 30 may have sufficient processing capacity to edit the high-resolution video. At this time, the electronic device 40 may directly edit the high-resolution video, and the video editing time may not be lengthened. In this way, the video of the target resolution can be adaptively selected for editing based on the load of the processor 30, and the user experience can be improved. It can be understood that the seventh predetermined threshold of the load of the processor 30 may be equal to the first predetermined threshold, or may be different from the first predetermined threshold, which is not limited in the embodiments of the present disclosure.

Referring to FIG. 1 and FIG. 17, when the post-processing is the sharing of the data, the process at S9 of performing post-processing to the data may include the following processes.

S931, receiving user's video sharing input.

S932, obtaining the load of the processor 30 of the electronic device 40 and the communication bandwidth between the movable platform 100 and a communication access device.

S933, sharing the high-resolution video based on the video sharing input when the load of the processor 30 and the communication bandwidth between the movable platform 100 and the communication access device both meet a sixth predetermined condition.

S934, sharing the low-resolution video based on the video sharing input when any one of the load of the processor 30 and the communication bandwidth between the movable platform 100 and the communication access device does not meet the sixth predetermined condition.

Referring to FIG. 1, in some embodiments, the processes at S931, S932, S933, and 934 can be executed by the executor 70. That is, when the program codes are being executed, the executor 70 can be used to receive user's video sharing input, obtain the load of the processor 30 of the electronic device 40 and the communication bandwidth between the movable platform 100 and a communication access device, share the high-resolution video based on the video sharing input when the load of the processor 30 and the communication bandwidth between the movable platform 100 and the communication access device both meet a sixth predetermined condition, and share sharing the low-resolution video based on the video sharing input when any one of the load of the processor 30 and the communication bandwidth between the movable platform 100 and the communication access device does not meet the sixth predetermined condition.

More specifically, the movable platform 100 may share videos via Wi-Fi and Bluetooth communication, and the movable platform 100 may also share videos via mobile data networks such as 2G/3G/4G/5G. When the movable platform 100 shares a video through Bluetooth communication, the communication access device may be a terminal that is matched and connected with the movable platform 100 through Bluetooth. When the movable platform 100 shares a video through Wi-Fi communication, the communication access device may be a wireless access point (AP). When the movable platform 100 shares a video through a 2G/3G/4G/5G mobile data network, the communication access may be a communication based station. It can be understood that the movable platform 100 may also share videos through wired communication.

More specifically, the user may enter the video sharing input instruction through physical buttons or virtual buttons. After the electronic device 40 receives the user's video sharing input instruction, the executor 70 may obtain the load of the processor 30 of the electronic device 40 and the communication bandwidth between the movable platform 100 and the communication access device (e.g., the wireless AP, the terminal, or the communication base station). At this time, if the load of the processor 30 is less than an eighth predetermined threshold, and the communication bandwidth between the movable platform 100 and the communication access device is greater than a ninth predetermined threshold, the executor 70 may control the 100 to share the high-resolution video. At this time, if the load of the processor 30 is greater than or equal to the eighth predetermined threshold, and the communication bandwidth between the movable platform 100 and the communication access device is less than or equal to the ninth predetermined threshold, the executor 70 may control the 100 to share the low-resolution video. It can be understood that the eighth predetermined threshold of the load of the processor 30 may be equal to the first predetermined threshold, or may be different from the first predetermined threshold, which is not limited in the embodiments of the present disclosure. The ninth predetermined threshold of the communication bandwidth between the movable platform 100 and the communication access device may be equal to the fourth predetermined threshold, or may be different from the fourth predetermined threshold, which is not limited in the embodiments of the present disclosure.

It can be understood that during the video sharing process, the sharing of a high-resolution video may need more space for resource scheduling of the processor 30 and the communication bandwidth of the communication link. If the load of the processor 30 is high, or the communication bandwidth is small, the sharing process of a high-resolution video may be relatively slow, while the sharing process of a low-resolution video may be relatively fast. At this time, low-resolution videos should be shared to speed up the video sharing process and reduce the video sharing time. If the load of the processor 30 is low, and the communication bandwidth is large, the movable platform 100 may directly share the high-resolution videos, and the time for video sharing will not be very long. In this way, based on the load of the processor 30 and the communication bandwidth, the video of the target resolution can be adaptively selected for sharing, and the user experience can be improved.

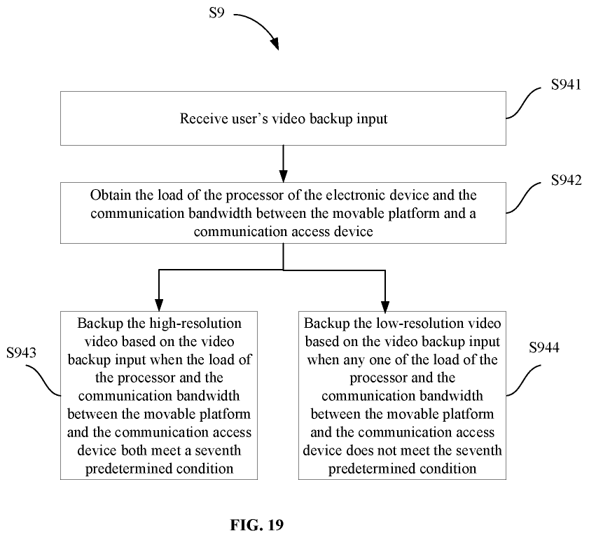

Referring to FIG. 1 and FIG. 19, in some embodiments, when the post-processing is to backup data, the process at S9 of performing post-processing to the data may include the following processes.

S941, receiving user's video backup input.

S942, obtaining the load of the processor 30 of the electronic device 40 and the communication bandwidth between the movable platform 100 and a communication access device.

S943, backup the high-resolution video based on the video backup input when the load of the processor 30 and the communication bandwidth between the movable platform 100 and the communication access device both meet a seventh predetermined condition.

S944, backup the low-resolution video based on the video backup input when any one of the load of the processor 30 and the communication bandwidth between the movable platform 100 and the communication access device does not meet the seventh predetermined condition.

Referring to FIG. 1, in some embodiments, the processes at S941, S942, S943, and 944 can be executed by the executor 70. That is, when the program codes are being executed, the executor 70 can be used to receive user's video backup input, obtain the load of the processor 30 of the electronic device 40 and the communication bandwidth between the movable platform 100 and a communication access device, backup the high-resolution video based on the video backup input when the load of the processor 30 and the communication bandwidth between the movable platform 100 and the communication access device both meet a seventh predetermined condition, and backup the low-resolution video based on the video backup input when any one of the load of the processor 30 and the communication bandwidth between the movable platform 100 and the communication access device does not meet the seventh predetermined condition.

In some embodiments, data backup may refer to the data backup to the cloud. The electronic device 40 may transmit data to the cloud for backup through any suitable communication methods, such as Wi-Fi, Bluetooth, mobile data network, etc.

More specifically, the user may enter the video backup input instruction through physical buttons or virtual buttons. After the electronic device 40 receives the user's video backup input instruction, the executor 70 may obtain the load of the processor 30 of the electronic device 40 and the communication bandwidth between the movable platform 100 and the communication access device (e.g., the wireless AP, or the communication base station). At this time, if the load of the processor 30 is less than a tenth predetermined threshold, and the communication bandwidth between the movable platform 100 and the communication access device is greater than an eleventh predetermined threshold, the executor 70 may control the movable platform 100 to back up the high-resolution videos. If the load of the 30 is greater than or equal to the tenth predetermined threshold, and the communication bandwidth between the movable platform 100 and the communication access device is less than the eleventh predetermined threshold, the executor 70 may control the movable platform 100 to back up the low-resolution videos. Similarly, the tenth predetermined threshold of the load of the processor 30 may be equal to the first predetermined threshold, or may be different from the first predetermined threshold, which is not limited in the embodiments of the present disclosure. The eleventh predetermined threshold of the communication bandwidth between the movable platform 100 and the communication access device may be equal to the fourth predetermined threshold, or may be different from the fourth predetermined threshold, which is not limited in the embodiments of the present disclosure.

It can be understood that during the video backup process, the backup of a high-resolution video may need more space for resource scheduling of the processor 30 and the communication bandwidth of the communication link. If the load of the processor 30 is high, or the communication bandwidth is small, the backup process of a high-resolution video may be relatively slow, while the backup process of a low-resolution video may be relatively fast. At this time, low-resolution videos should be backed up to speed up the video backup process and reduce the video backup time. If the load of the processor 30 is low, and the communication bandwidth is large, the movable platform 100 may directly backup the high-resolution videos, and the time for video backup will not be very long. In this way, based on the load of the processor 30 and the communication bandwidth, the video of the target resolution can be adaptively selected for backup, and the user experience can be improved.

An embodiment of the present disclosure further provides a computer-readable storage medium on which a computer program can be stored. The computer program can be executed by a processor to complete the data synchronization method described in any one of the above embodiments. In some embodiments, the processor may be an integration of the processor 60 in the movable platform 100 (or the processor 30 of the electronic device 40) and the executor 70 for implementing the functions of the processor 60 in the movable platform 100 (or the processor 30 of the electronic device 40) and the executor 70.

For example, referring to FIG. 2, when the computer program is executed by the processor, the processor can be caused to complete the following processes.

S1, store data in a target storage medium.

S2, obtain a data synchronization strategy.

S3, determine a target synchronization medium based on the synchronization strategy.

S4, synchronize data to the target synchronization medium based on the synchronization strategy.

In another example, referring to FIG. 3, when the computer program is executed by the processor, the processor can be caused to complete the following processes.

S411, obtain the load of the processor 30 of the electronic device 40.

S412, synchronize the data in the target internal storage medium to the target internal synchronization medium when the load of the processor 30 of the electronic device 40 meets the first predetermined condition.

In another example, referring to FIG. 10, when the computer program is executed by the processor, the processor can be caused to complete the following processes.

S471, detecting whether there is a file with the same name as the first file in the target synchronization medium.

S472, storing the data in the target synchronization medium in the form of the first file when there is no file with the same name as the first file in the target synchronization medium.

S473, storing the data in the target synchronization medium in the form of a second file when there is a file with the same name as the first file in the target synchronization medium.

In the present description, descriptions of reference terms such as “an embodiment,” “some embodiments,” “illustrative embodiment,” “example,” “specific example,” or “some examples,” mean that characteristics, structures, materials, or features described in relation to the embodiment or example are included in at least one embodiment or example of the present disclosure. In the present description, illustrative expression of the above terms does not necessarily mean the same embodiment or example. Further, specific characteristics, structures, materials, or features may be combined in one or multiple embodiments or examples in a suitable manner.

Any process or method described in the flowcharts or in other manners may be understood as a module, a fragment, or a portion of code that includes one or more executable instructions for implementing a particular logic function or a particular process. The scope of the embodiments of the present disclosure includes additional implementations. The embodiments may not be implemented according to the order of the illustrations or discussions. Some or all functions may be implemented concurrently or in a reverse order, which should be understood by those of ordinary skill in the art.

The logic and/or step described in the flowcharts or in other manners may be considered as, for example, an ordered list of executable instructions for implementing the logic functions and may be embodied in any computer-readable storage medium for use by an instruction execution system, an apparatus, a device (e.g., a computer-based system, a system including a processor, or other instruction execution system where an apparatus or a device retrieves and executes the instructions), or combinations thereof. In the specification, “computer-readable storage medium” may be any medium that contains, stores, communicates, propagates, or transfers programs for use in the instruction execution system, the apparatus, the device, or combinations thereof. For example, the computer-readable storage medium may include, but is not limited to, an electrical connection including one or more wires (an electronic device), a portable computer disk cartridge (a magnetic device), a random-access memory (RAM), a read-only memory (ROM), an erasable programmable read-only memory (EPROM or flash memory), an optical fiber device, and a portable optical disk read-only memory (CD-ROM). In addition, the computer-readable storage medium may be papers printed with the programs or other suitable medium because the papers or other medium may be optically scanned, edited, interpreted, or processed in other suitable manners to electronically obtain the programs, which can then be stored in the computer-readable storage medium.

Some or all portions of the embodiments may be implemented in hardware, software, firmware, or combinations thereof. In some embodiments, the processes or methods may be implemented in software or firmware stored in the memory and executed by a suitable instruction execution system. In some other embodiments, the processes or methods may be implemented in hardware including any one of the following well-known technical solutions or combinations thereof, such as discrete logic circuits including logic gate circuits for implementing logic functions on digital data signals, application specific integrated circuits including suitable combination logic gate circuits, programmable gate arrays (PGA), and field programmable gate arrays (FPGA).

Those of ordinary skill in the art can understand that all or some of the processes implementing the foregoing embodiments of the present disclosure may be implemented by programs instructing the related hardware the programs may be stored in the computer-readable storage medium. When being executed, the programs perform the processes implementing all or some method embodiments.

In addition, the functional units in the embodiments of the present disclosure may be integrated into one processing module, may be distributed to a plurality of physically separate units, or may have two or more units integrated into one module. The integrated modules may be implemented in hardware or in software function modules. When being implemented in software function modules and used or sold as an independent product, the integrated modules may be stored in the computer-readable storage medium.

The storage medium may be a read-only memory (ROM), a magnetic disk, or an optical disk. The foregoing descriptions are merely some implementation manners of the present disclosure, but the scope of the present disclosure is not limited thereto. Without departing from the spirit and principles of the present disclosure, any modifications, equivalent substitutions, and improvements, etc., shall fall within the scope of the present disclosure. The scope of the invention should be determined by the appended claims.

What is claimed is:

1. A method of synchronizing data in a movable platform, comprising:
storing the data in a target storage medium;
obtaining a synchronization strategy for the data;
determining a target synchronization medium based on the synchronization strategy; and
synchronizing data to the target synchronization medium based on the synchronization strategy.

2. The method of claim 1, wherein:
the target storage medium includes one or more of an internal storage medium, a first external storage medium, or a second external storage medium;
the target synchronization medium includes one or more of the internal storage medium, the first external storage medium, or the second external storage medium; and
the movable platform includes an electronic device, the internal storage medium and the first external storage medium being disposed in the electronic device, and the second external storage medium being disposed in an external device connected to the movable platform.

3. The method of claim 1, wherein:
the synchronization strategy includes a user input, the user input including a synchronization instruction input through at least one of a virtual button or a physical button to set the synchronization strategy.

4. The method of claim 1, wherein:
the synchronization strategy is predetermined.

5. The method of claim 1, wherein:
the synchronization strategy includes one or more of an active synchronization, a passive synchronization, or an asynchronous synchronization; and
the method further comprises:
receiving a synchronization instruction input by a user and synchronizing the data to the target synchronization medium in response to the synchronization strategy being the passive synchronization.

6. The method of claim 5, wherein:
the movable platform includes an electronic device; and
in response to the synchronization strategy being the active synchronization, actively synchronizing the data to the target synchronization medium when the electronic device meets a first predetermined condition, the first predetermined condition being a processor load of the electronic device being less than a first predetermined threshold.

7. The method of claim 5, wherein:
the movable platform includes an electronic device;
the movable platform is connected to an external device; and
in response to the synchronization strategy being the active synchronization, actively synchronizing the data to the target synchronization medium when at least one of the movable platform or the external device meets a second predetermined condition, the second predetermined condition including one or more of a processor load of the electronic device being less than a second predetermined threshold, a processor load of the external device being less than a third predetermined threshold, or a communication bandwidth of a communication link between the movable platform and the external device being greater than a fourth predetermined threshold.

8. The method of claim 5, wherein:
in response to the synchronization strategy being the asynchronous synchronization, a data synchronization function of the target storage medium is turned off to stop data synchronization;
the synchronization strategy is the asynchronous synchronization in response to failure of an authentication of the target synchronization medium and the target storage medium; and
the method further comprises:
synchronizing the data to the target synchronization medium in response to the authentication of the target synchronization medium and the target storage medium being successful.

9. The method of claim 2, wherein:
the electronic device includes a plurality of internal storage mediums, the plurality of internal storage mediums including one or more target internal storage mediums set as the target storage medium and one or more target internal synchronization mediums set as the target synchronization medium; and
synchronizing the data to the target synchronization medium based on the synchronization strategy includes:
obtaining a processor load of the electronic device; and
in response to the processor load meeting a first predetermined condition, synchronizing the data in the target internal storage medium to the target internal synchronization medium.

10. The method of claim 2, wherein when the target storage medium is the internal storage medium, and the target synchronization medium is the first external storage medium, synchronizing the data to the target synchronization medium based on the synchronization strategy includes:
obtaining a processor load of the electronic device; and
in response to the processor load meeting a first predetermined condition, synchronizing the data in the internal storage medium to the first external storage medium.

11. The method of claim 2, wherein when the target storage medium is the internal storage medium and the first external storage medium, and the target synchronization medium is the second external storage medium, synchronizing the data to the target synchronization medium based on the synchronization strategy includes:
obtaining a processor load and a communication bandwidth of a communication link between the movable platform and the external device, the processor load including one or more of a processor load of the electronic device or a processor load of the external device; and
in response to the communication bandwidth and the processor load meeting a second predetermined condition, synchronizing the data in the internal storage medium and/or the first external storage medium to the second external storage medium.

12. The method of claim 1, wherein:
the data is stored in the target storage medium in a form of a first file; and
synchronizing the data to the target synchronization medium based on the synchronization strategy includes:
detecting whether there is a file with a same name as the first file in the target synchronization medium;
storing the data in the target synchronization medium in the form of the first file when there is no file with the same name as the first file in the target synchronization medium; and
storing the data in the target synchronization medium in a form of a second file when there is a file with the same name as the first file in the target synchronization medium.

13. The method of claim 1, further comprising:
obtaining a target summary storage medium, the target summary storage medium being one or more of the internal storage medium, the first external storage medium, or the second external storage medium; and
synchronizing target summary data to the target summary storage medium, wherein
the target summary data includes data stored in the target storage medium and data synchronized to the target synchronization medium.

14. The method of claim 1, wherein storing the data in the target storage medium includes:
determining the target storage medium based on a user input or predetermination.

15. The method of claim 2, wherein:
the target storage medium includes the internal storage medium, the first external storage medium and the second external storage medium; and
storing the data in the target storage medium includes:
obtaining the communication bandwidth of the communication link between the movable platform and the external device; and
in response to the communication bandwidth not meeting a third predetermined condition, caching all or part of the data in at least one of the internal storage medium or the first external storage medium; and
in response to the communication bandwidth meeting the third predetermined condition, sending all or part of the data cached in at least one of the internal storage medium or the first external storage medium to the second external storage medium.

16. The method of claim 1, wherein:
the data includes videos having a plurality of predetermined resolutions; and
storing the data in the target storage medium includes:
determining a target resolution of the video and storing the video of the target resolution, the target resolution being one of the plurality of predetermined resolutions.

17. The method of claim 16, wherein storing the plurality of videos of predetermined resolutions at the same time includes:
determining the target resolution of the video synchronized to the target synchronization medium based on the user input; and
synchronizing the data to the target synchronization medium based on the synchronization strategy includes:
synchronizing the video of the target resolution to the target synchronization medium.

18. The method of claim 16, wherein storing the plurality of videos of predetermined resolutions at the same time further includes:
obtaining the communication bandwidth of the communication link between the movable platform and the external device;
determining the target resolution of the video synchronized to the target synchronization medium based on the communication bandwidth; and
synchronizing the data to the target synchronization medium based on the synchronization strategy includes:
synchronizing the video of the target resolution to the target synchronization medium.

19. A movable platform comprising:
a processor; and
a memory storing program instructions that, when being executed by the processor, cause the processor to:
store data in a target storage medium;
obtain a synchronization strategy for the data;
determine a target synchronization medium based on the synchronization strategy; and
synchronize data to the target synchronization medium based on the synchronization strategy.

20. A data synchronization system comprising:
a movable platform; and
an external device connected to the movable platform, wherein
the movable platform includes a processor and a memory storing program instructions that, when being executed by the processor, the program instructions cause the processor to:
store data in a target storage medium;
obtain a synchronization strategy for the data
determine a target synchronization medium based on the synchronization strategy; and
synchronize data to the target synchronization medium based on the synchronization strategy.
